(19) United States
(12) Patent Application Publication
(10) Pub. No.: US 2003/0125818 A1
(43) Pub. Date: Jul. 3, 2003

(54) Global equation solver and optimizer

(75) Inventor: Daniel P. Johnson, Fridley, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell Inc.

(21) Appl. No.: 10/032,682

(22) Filed: Dec. 28, 2001

(51) Int. Cl. G05B 13/02

(52) U.S. Cl. 700/28; 700/31; 700/46; 700/33; 700/34; 700/36

(57) ABSTRACT

A method to determine global optimality/feasibility/infeasibility when solving a quadratic system of modeling equations for industrial problems includes a bound propagation process to refine bounds and improve linearization, a local linear bounding process to determine feasibility and find approximately feasible solutions, a local linearization process to determine feasibility and local optimality, and a global subdivision search to branch and prune. Applications include solving and optimizing scheduling, planning, operations, inventory, suppliers, ordering, customers, and production problems.

### BACKGROUND

Planning and scheduling require solving and optimizing a set of nonlinear equations. Consider a plant that makes ice cream. The plant needs to make vanilla, strawberry, and chocolate ice cream, but there are a number of constraints, such as the amount of vanilla flavoring, strawberries, and chocolate available. There are scheduled deliveries of ice cream and orders to fill. When a truck rolls up and expects to be loaded with chocolate ice cream, for example. There are production constraints, such as needing to do chocolate last because after producing chocolate ice cream, the pipes must be cleaned before you can run anything else. This is a cost penalty for chocolate. While the plant is making one kind of ice cream it cannot produce anything else, because the equipment is committed to a particular product. Business managers would like to make as large a batch as possible because that minimizes the amount of time the system is down for transitions between products. On the other hand, storage space is limited. For example, chocolate syrup may start to build up. Trucks full of chocolate syrup sit in the plant parking lot and charge thousands of dollars a day until you can get them unloaded.

In managing plant operations, there are a series of continuous and discreet decisions to make. To get rid of the chocolate syrup, chocolate will need to be produced on Tuesday and strawberry on Wednesday and some time will need to be spent cleaning up after the chocolate. Those are discreet decisions, because a plant cannot only half make chocolate ice cream; the plant either makes it or not. Given a particular set of discrete decisions, a set of continuous decisions is made. How much chocolate ice cream should be produced? How much strawberry ice cream should be produced? How much chocolate is the plant going to have in the tanks at a particular time of day? How much chocolate will be produced in the next hour? Is it going to build up to the point where is blows the top off the tank? How much chocolate syrup is required? When does the plant start making strawberry? How fast will the strawberries be used up and when will the strawberries run out? Those are continuous decisions. Complications may arise, such when the guy who makes strawberry is late or when it takes longer than usual to clean up after the chocolate. Discrete and continuous decisions like these are used to set up a set of equations or constraints.

In addition, there are other motivations, such as market demand. A customer may be willing to pay twice as much for all chocolate ice cream as for half chocolate and half strawberry. Perhaps a plant manager is motivated to do a lot more vanilla, even though the supply schedule tells him he is not able to get to vanilla for a long time. Then, he will want to optimize production of vanilla as soon as the vanilla supplies arrive. Even more complex situations occur.

For a planning system, a set of equations derived from high-level constraints is solved to find the best solution based on certain criteria, such as profitability. This result tells whether the plan will work. If so, then more detailed constraints and criteria are added to the set of equations and the set of equations is solved for a schedule. Scheduling systems have a much larger set of equations to solve than planning systems. This puts a lot more stress on the solver and the solving technology.

Most current systems are planning systems, not scheduling systems, which are larger and harder to solve. Current methods are unable to solve scheduling problems within the necessary time for rapid modeling and simulation with optimum or near optimum solutions. Also, current methods suffer from a local optimality problem, where a local optimum in the solution space is incorrectly given as the solution when the actual global optimum lies elsewhere. Any system that suffers from the local optimality problem may not be able to find a solution, when a solution exists. In addition, some of the current methods are too slow. Furthermore, most current methods fail to find a solution without indicating if the problem is infeasible or not. The few methods that are able determine infeasibility have poor or slow convergence. Some examples of current methods are sequential linear programming, sequential quadratic programming, and trusted regions. All three of these suffer from the local optimality problem and when they fail, it is unknown whether the problem is infeasible or not. There is a need for an efficient method to quickly converge on a solution, to rigorously determine whether or not the problem is infeasible, and to find the global optimum instead of getting stuck in a local optimum.

### SUMMARY

The present invention solves both planning and scheduling problems by combining a number of technologies. It balances the safety of subdivision methods with the fast convergence of linearization methods, avoiding the local optimality problem. Also, the linearization methods rigorously determine whether or not the problem was infeasible. The present invention is a method of solving an operations problem. Operations problems comprehend both planning and scheduling problems. First, the method receives variables, relationships, and constraints. Then, it forms a set of non-convex quadratic equations based on them. The method solves the set of non-convex quadratic equations by applying a bound propagation process, a local linear bounding process, a local linearization process, and a global subdivision search. Finally, the method determines whether a solution is optimal, feasible, or infeasible. Thus, the present invention recognizes local optimality problems and goes beyond them to find a global solution, if one exists. If not, the present invention rigorously proves infeasibility. If there is a solution, it comes up with a solution.

### BRIEF DESCRIPTION OF THE DRAWINGS

FIG. 1 is a block diagram of example applications of the present invention.

FIG. 2 is a block diagram of a bounded region containing a solution space to solve for an optima using embodiments of the present invention.

FIG. 3 is a flow chart of a method embodiment of the present invention.

FIG. 4 is a more detailed flow chart than FIG. 3 and shows a method embodiment of the present invention.

FIG. 5 is a block diagram of a bounded region, like the one shown in FIG. 2, which is modified in a bound propagation and refinement subprocess of a method embodiment of the present invention, such as the method embodiments shown in FIGS. 3 and 4.

FIG. 6 is a flow chart of a local linear bounding subprocess of a method embodiment of the present invention, such as the method embodiments shown in FIGS. 3 and 4.

FIG. 7 is a flow chart of a linearization subprocess of a method embodiment of the present invention, such as the method embodiments shown in FIGS. 3 and 4.

### DETAILED DESCRIPTION

Methods for a global equation solver and optimizer are described. In the following detailed description, reference is made to the accompanying drawings, which form a part hereof. These drawings show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

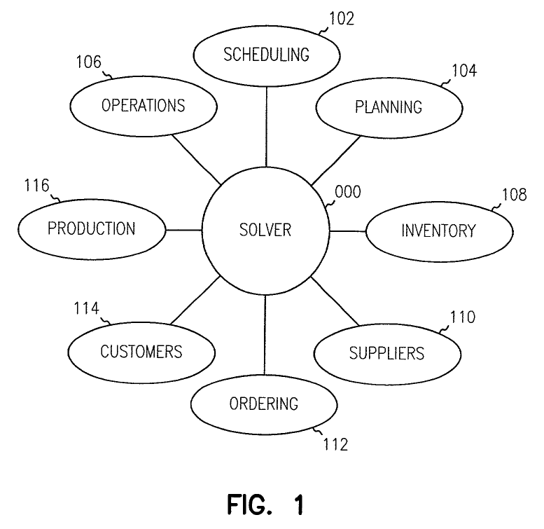

FIG. 1 is a block diagram of example applications of the present invention. The present invention is shown as a solver 100. The solver solves a set of equations, giving a set of variables and what they are equal to in the solution, if one exists. These variables are then translated into a business use, such as an operations plan, an accounting summary or some other useful, concrete, and tangible results. The solver is like an octopus, because customer orders interact with inventory, which in turn interacts with production facilities, which interacts with the business plan and so on. The solver is at the heart of all these activities.

The solver is run as a scheduling system at least on a daily basis. As a planning system, it is run about once a month with adjustments as events occur. Or run to interact with traders as they phone in opportunities. The solver 100 can be applied to scheduling 102, planning 104, and other operations 106.

Planning is the forecasting of the average performance of a plant (a collection of interconnected processes) over some specified period, such as a month or a year. The plan specifies what inputs are needed and how they are to be used to produce plant outputs. The plan usually includes forecasts of the values of individual process performance parameters such as yields, product qualities, flow rates, temperatures, and pressures. The plan also includes economic information about the impact of changes in parameters on plant profitability.

Scheduling is the specification of the inputs to and outputs from each process and inventory, plus the timing and sequencing of each production operation, whether batch or continuous, over some short scheduling period, such as a week or 10 days. Although the horizon is a week or 10 days, today's operation is the most important. Operations are not averaged over the scheduling period; rather, time and operations move continuously from the beginning of the period to the end. Ideally, the schedule is revised each day as needed so that it always starts from current actual performance.

Additionally, the solver can be applied to inventory 108, suppliers 110, and ordering 112. Also, it can be applied to customers 114 and production 116. For example, a business analyst takes a phone call from a trader who says he has a chance to sell this much of something and asks the business analyst if he can make it in time. The business analyst quickly runs the solver to decide whether it is a good opportunity or not. Another example is storing routine results in an executive information system for general business planning, such as forecasting whether profit numbers will be made for the quarter. Another example is an operations person who uses the results to decide what temperature to crank his unit. Another example is a factory floor scheduler with a cell phone and spreadsheet, who directs operations people based on the results. In addition, the present invention has many other applications.

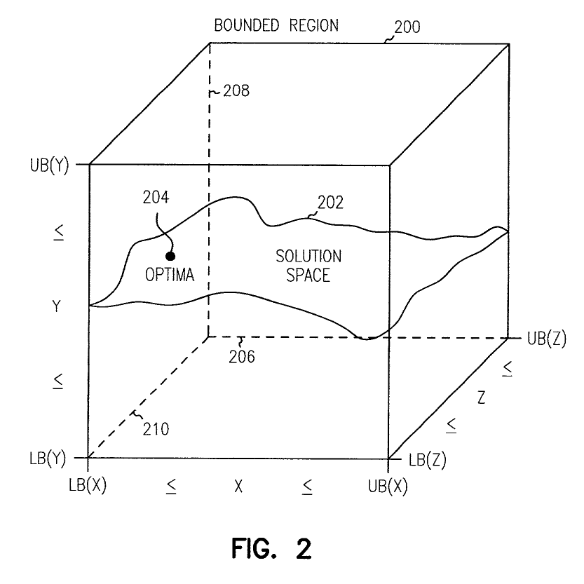

FIG. 2 is a block diagram of a bounded region 200 containing a solution space 202 to solve for an optima 204 using embodiments of the present invention. Initially, the solution space is unknown, but the bounded region 200 can be determined from the set of equations to solve. The ranges of variables in the set of equations define certain bounds. The exemplary bounded region 200 is shown in three-dimensional space with x-206, y-208, and z-axes 210. This represents a rather simple set of equations with 3 variables. A typical set of equations has 10,000 variables, so a typical bounded region would have 10,000 dimensions. However, the three dimensions shown in FIG. 2 are easier to conceptualize. In FIG. 2, the x variable has lower and upper bounds, LB(X) and UB(X) respectively. The y variable has lower and upper bounds, LB(Y) and UB(Y) respectively. The z variable has lower and upper bounds, LB(Z) and UB(Z) respectively. The bounded region 200 is the intersection of these lower and upper bounds and the solution space 202 is contained within the bounded region 200.

Assuming the problem is not infeasible, the solution space 202 is a set of feasible solutions in a feasible region, one of which is the optima 204. A feasible region is the set of all points satisfying all of the problem's constraints and restrictions defined in the set of equations. For example, in a feasible solution for an oil refinery, no tanks overflow or underflow. Often, for a scheduling problem, the goal is to meet the schedule with a feasible solution, rather than an optimal solution. For example, given a certain amount of inventory and shipments, a feasible solution makes the shipments without using up too much of the inventory. Because the deals have already been made, any extra product is stored, not sold. An infeasible problem occurs when the feasible region is empty, i.e. it contains no points. By definition, an infeasible problem has no optimal solution. An optima or optimal solution is a point in the feasible region with the largest objective function value, for a maximization problem. Similarly, for a minimization problem, the optimal solution is a point in the feasible region with the smallest objective function value. An objective function is some function of particular decision variables to be minimized or maximized. For example, a simple objective function to maximize is (weekly revenues)−(raw material purchase costs)−(other variable costs). Some other examples of optimality measures or objective functions are minimum turnover, minimum costs, accomplishing work in minimum time, maximizing a high margin product, and the like. The optima is defined by pre-determined criteria, such as least cost or most profit that are included as input to the present invention. A global optima is the optima over the entire range of variables as opposed to a local optima, which is the optima only in a local area.

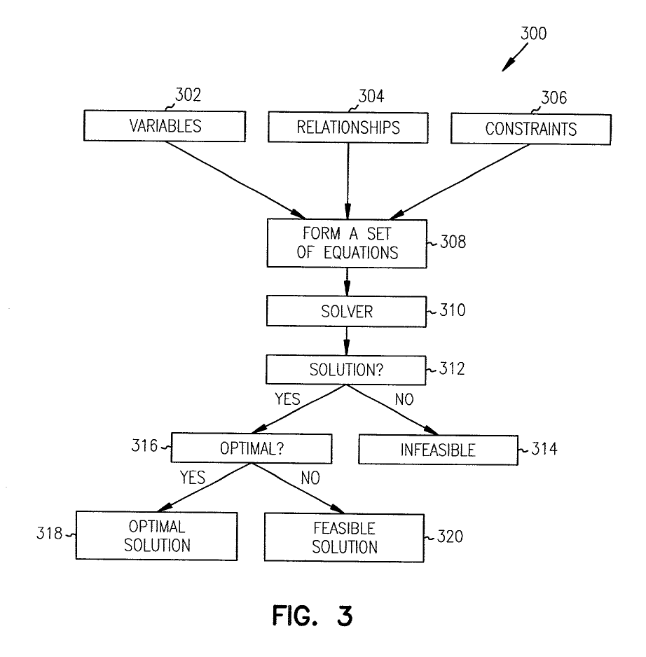

FIG. 3 is a flow chart of a method embodiment 300 of the present invention. One aspect of the present invention is a method 300 of solving an operations problem. Operations problems comprehend both planning and scheduling problems. For example, problems include maximizing profits, meeting shipments, meeting production schedules, meeting product specification requirements, and other business problems. Operations problems are optimization problems in industries as diverse as banking, education, forestry, petroleum, and trucking. The method 300 comprises receiving variables 302, relationships 304, and constraints 306. The variables 302 are things like qualities, quantities, timing, and the like. Relationships 304 express how the variables 302 interrelate, such as how speed relates to quality. For example, in mixing things, the relative quantities effect the quality of the mixture. Other examples are relationships 304 based on the physics of a plant and relationships 304 based on economics, such as cost and revenue. Some examples of constraints 306 in refinery applications are tank limits, product specifications, gasoline octane ratings, operating limits and the like.

The method 300 comprises forming a set of non-convex quadratic equations 308 based on the variables 302, relationships 304, and constraints 306. Some example equations are formed by the definition of the problem. Other example equations are formed by physical constraints, such as the capacity of a tank. Still other example equations are formed by the physics of a process being modeled. Equations that are not in quadratic form can be converted to quadratic form by standard approximation methods. Convex equations have solution sets such that a line segment joining any pair of points in the solution set is wholly contained in the solution set. Non-convex equations do not have this property. Generally, when a convex object, such as a beach ball is put on a flat surface, it will be touching at one point. Non-convex objects basically have some indentation or dimple in it. Non-convex equations usually have multiple local pseudo-solutions, meaning they are not solvable with current methods having the local optimality problem.

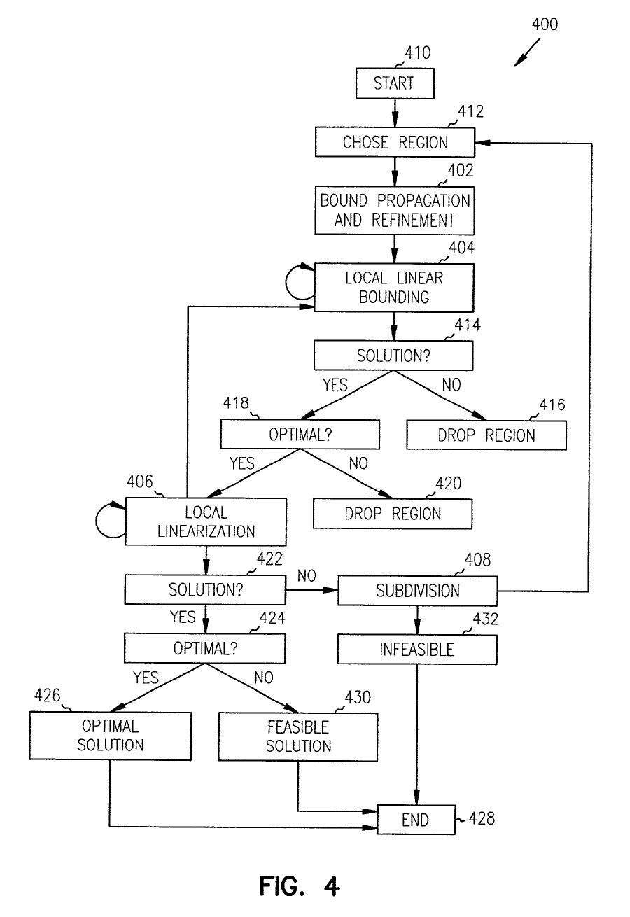

The method 300 further comprises solving the set of non-convex quadratic equations by applying a bound propagation process, a local linear bounding process, a local linearization process, and a global subdivision search. This is shown in FIG. 3 as the solver 310. Solving the equations is described in more detail below with reference to FIG. 4. The method 300 further comprises determining whether a solution is optimal, feasible, or infeasible. FIG. 3 shows the solver 310 determines whether a solution exits 312. If no solution exists, then the solver 310 determines that the problem is infeasible 314. If a solution exists, then the solver 310 determines whether the solution is optimal 316. The solver determines either that the solution is optimal 318 or feasible 320.

The solution to the set of non-convex quadratic equations has many uses. (See FIG. 1.) In one embodiment, the solution is a schedule for the manufacturing process. In another embodiment, the solution is a schedule for operating an oil refinery. In another embodiment, the solution is a plan for the manufacturing process. In another embodiment, the solution is a plan for operating an oil refinery.

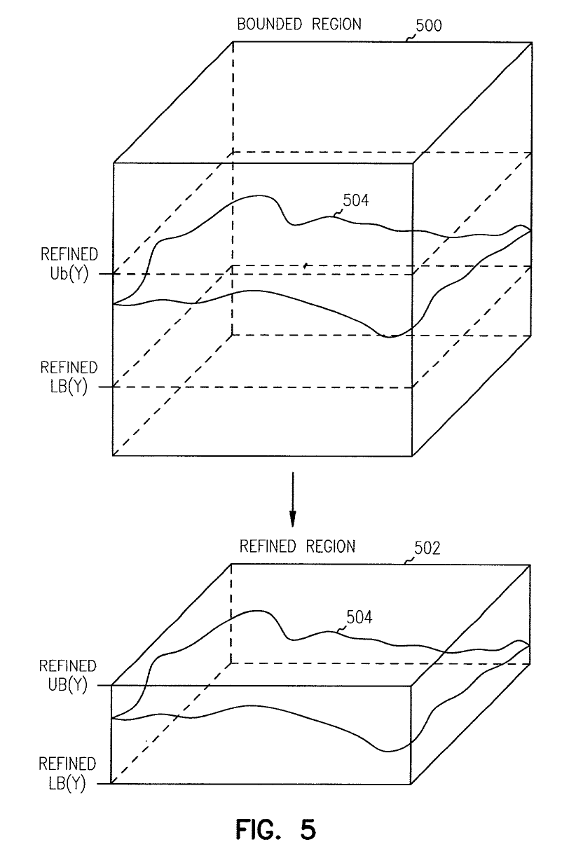

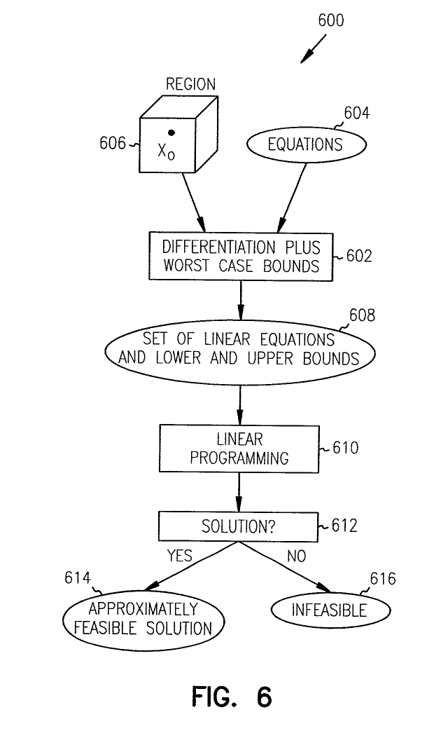

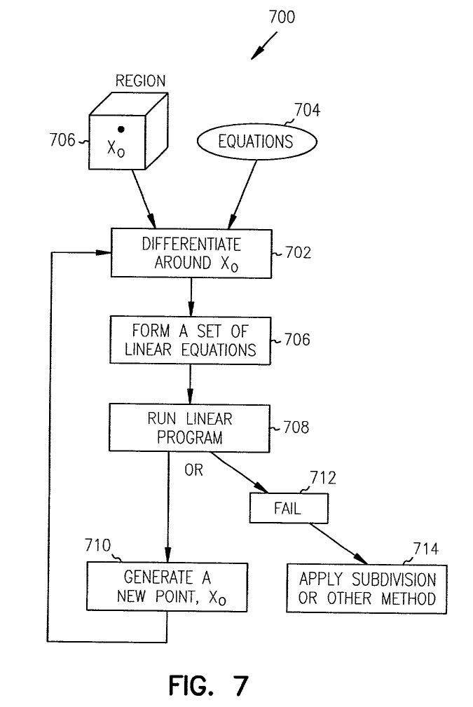

FIG. 4 is a more detailed flow chart than FIG. 3 and shows a method embodiment 400 of the present invention. One aspect of the present invention is a method 400 comprising solving the set of non-convex quadratic equations by applying a bound propagation process 402, a local linear bounding process 404, a local linearization process 406, and a global subdivision search 408. Three of these processes are described below with reference to FIGS. 5-7. The bound propagation process 402 is described below with reference to FIG. 5. The local linear bounding process 404 is described below with reference to FIG. 6. The local linearization process 406 is described below with reference to FIG. 7.

The global subdivision search 408 is done over a bounded region, like the one shown in FIG. 2 using branch and prune logic. For branching, the solver starts with the whole bounded region and if no solution is found, splits the region in half, first searching one half and then the other until a solution is found or the problem is determined to be infeasible. For pruning, only bounded regions that might contain a solution need to be examined. There are many alternate methods for performing the global subdivision search. One alternate method is to pick the most infeasible constraint and find the most infeasible variable in it.

The combination of processes in method 400 work together to create advantages over current methods. The bound propagation process 402 gives the method 400 improved performance over current methods. The local linear bounding process 404 rigorously proves infeasibility locally. The local linearization process 406 improves time to convergence on a solution over current methods. The global subdivision search 408 helps to avoid the local optimality problem. These advantages help reduce project cycles, integrate operations for better decisions, and increase profits by providing more accurate, timely information for real-time decisions.

Another aspect of the present invention is a machine-accessible medium having associated content capable of directing the machine to perform a method 400 of solving a set of non-convex quadratic equations. At the start 410 in FIG. 4, the method 400 comprises selecting a region bounding all variables 412. A bound propagation process is applied to the region to refine the bounds and improve linearization 402. A local linear bounding process is applied to the region to determine feasibility and to find approximately feasible solutions 404. The local linear bounding process is optionally repeated. The method 400 determines if there is no potential for a solution 414 within the region. If so, the region is eliminated from consideration 416. The method 400 determines if there is no potential for an optimal solution 418. If so, the region is eliminated from consideration 420.

A local linearization process is applied to the region to determine feasibility and local optimality 406. The local linearization process is optionally repeated. The method 400 determines if there is a solution 422 and if so, if it is optimal 424. Upon finding an optimal global solution 426, the optimal global solution and information indicating optimality are provided and the method 400 ends 428. Upon finding a feasible global solution 430, the feasible global solution and information indicating feasibility are provided and the method 400 ends 428. Upon determining local infeasibility, the region is eliminated from consideration. Upon determining global infeasibility 432, information indicating infeasibility is provided and the method 400 ends 428. Upon not finding a solution, a global subdivision search 408 is applied to the region to produce two or more regions and the bound propagation 402, local linear bounding 404, and local linearization 406 processes are iteratively applied to each of the two or more regions, until the solution is determined to be optimal 426, feasible 430, or infeasible 432.

In one embodiment, the method 400 further comprises receiving input variables, constraints, and equations. In another embodiment, the method 400 further comprises receiving a measure of optimality used to determine the global optimal solution. In another embodiment, the method 400 further comprises receiving a measure of feasibility used to determine the global feasible solution. In another embodiment, the method 400 further comprises providing a schedule for operating a plant. In another embodiment, the method 400 further comprises providing a plan for operating a plant.

Another aspect of the present invention is a process 400 of solving a set of non-convex quadratic equations. The process 400 comprises selecting a region bounding all variables 412. A bound propagation process 402 is applied to the region to refine the bounds and improve linearization. A local linear bounding process 404 is applied to the region to determine feasibility and to find approximately feasible solutions. A local linearization process 406 is applied to the region to determine feasibility and local optimality. Upon finding a solution after the local linearization process, the solution is provided. Upon determining infeasibility, the region is eliminated from consideration. Upon not finding the solution after the local linearization process, a global subdivision search 408 is applied to the region to produce two or more regions and the bound propagation 402, local linear bounding 404, and local linearization 406 processes are iteratively applied to each of the two or more regions, until it is determined that the solution is optimal, feasible, or infeasible.

In one embodiment of the process 400, the local linearization process 406 is the local linear bounding process 404.

FIG. 5 is a block diagram of a bounded region, like the one shown in FIG. 2, which is modified in a bound propagation and refinement subprocess of a method embodiment of the present invention, such as the method embodiments shown in FIGS. 3 and 4. FIG. 5 shows a bounded region 500 with refined upper and lower bounds along the y-axis to produce a refined region 502, which is closer to the solution space 504 and reduces the space to search. Once bounds are refined, they are propagated. For example, if one of the equations is X=Z+Y, once Y is bound, then that can be propagated to X and Z so that X and Z are also bound, reducing the size of the region to search.

FIG. 6 is a flow chart of a local linear bounding subprocess 600 of a method embodiment of the present invention, such as the method embodiments 300, 400 shown in FIGS. 3 and 4. In one embodiment, the local linear bounding subprocess 600 determines infeasibility and finds approximately feasible solutions. In one embodiment, the local linear bounding process 600 comprises performing differentiation 602 on equations 604 in the region 606. The region 606 includes an initial point (x₀). Differentiation 602 is done around the x₀. The lower and upper bounds on the variables in the region are determined 608. A linear programming process is applied to the linear equations in the region 610. The local linear bounding subprocess 600 determines whether a solution exists in the region 612. Upon finding a solution exists, local feasibility is determined 614. Upon finding local infeasibility, global infeasibility is determined 616.

In one embodiment, the initial point is a trial solution closest to a feasible solution. In another embodiment, the initial point is a trial solution closest to being the optimal solution. In another embodiment, the initial point is the largest. In another embodiment, the initial point is the smallest. Other embodiments include using discrete search techniques.

FIG. 7 is a flow chart of a linearization subprocess 700 of a method embodiment of the present invention, such as the method embodiments 300, 400 shown in FIGS. 3 and 4. In one embodiment, the local linearization process 700 comprises performing differentiation 702 at a point in the bounded region 704. A set of linear equations is formed 706. A linear programming process is applied to the linear equations in the bounded region 708. A new point is generated in the bounded region 710 and the local linearization process is repeated with the new point. If the linear program fails to generate a new point 712, then the global subdivision search or some other method is applied 714. In another embodiment, the local linearization process 700 has quadratic convergence, giving it fast performance.

### EXAMPLE EMBODIMENTS

The following example embodiments provide methods for the global solution and optimization of systems of quadratic equations, with extensions to general nonlinear functions.

### Basic Definitions

Let ƒ(x): [symbol] ⁿ→ [symbol] ^{m} be a quadratic function of the form

$${f}_{k} ( x ) = {C}_{k} + {\sum }_{i} {A}_{ki} {x}_{i} + {\sum }_{ij} {B}_{kji} {x}_{j} {x}_{i} . \qquad ( 1.1 )$$

The problem we wish to solve will have the following form.

min ƒₖ(x):kεK₀

lbₖ≦ƒₖ(x)≦ubₖ:∀kεK₁

u⁰≦x≦v⁰ (1.2)

(The set K₀must include only a single linear function.)

With informal notation, we shall write the functions in the matrix/vector notation

ƒ(x)=C+Ax+Bxx (1.3)

when we wish to consider all the functions, and in the forms

ƒ⁰(x)=C⁰+A⁰x

ƒ¹(x)=C¹+A¹x+B¹xx (1.4)

when we wish to consider the three classes of functions.

Notationally, Bxy is to be interpreted as a multilinear

$$Bxy = {\sum }_{ij} {B}_{kji} {x}_{j} {y}_{i}$$

and the linear form Bx is equivalent to the matrix

$${( Bx )}_{ki} = {\sum }_{j} {B}_{kji} {x}_{j} .$$

In addition, the transpose of B is defined as B*xy=Byx, with the immediate equality B*ₖⱼᵢ=Bₖᵢⱼ.

Define the positive and negative functions

(x)₊=max(x,0)≧0

(x)₋=min(x,0)≦0 (1.5)

We define a measure of the infeasibility of a particular point to be

$$Δ ( x ) = {\sum }_{k ∈ {K}_{1}} {Δ}_{k} ( x ) \qquad ( 1.6 )$$

where

Δₖ(x)=max((ƒₖ(x)−ubₖ)₊,(lbₖ−ƒₖ(x))₊). (1.7)

(As a result, Δ(x)≧0, and Δ(x)=0 only if the point x is feasible.)

In the course of solving the problem (1.2) above, we will be solving a sequence of subsidiary problems. These problems will be parameterized by a trial solution and a set of point bounds,

\overline{x}

u≦x≦v. (1.7)

From that we can compute a set of gradient bounds

F=(B)₊u+(B)₋v

G=(B)₊v+(B)₋u (1.8)

so that

u≦x≦v [symbol] F≦Bx≦G. (1.9)

We will also require that the trial solution also satisfy the bounds

u≦\overline{x}≦v. (1.10)

We define the row vector e={1, . . . ,1} so that we can compute the maximum infeasibility for the bounds

$$Δ ( u , v ) = e ( G - F ) ( v - u ) = {\sum }_{ki} ( {G}_{ki} - {F}_{ki} ) ( {v}_{i} - {u}_{i} ) \qquad ( 1.11 )$$

or equivalently

$$Δ ( u , v ) = e \vert B \vert ( v - u ) ( v - u ) = {\sum }_{kii} \vert {B}_{kji} \vert ( {v}_{j} - {u}_{j} ) ( {v}_{i} - {u}_{i} ) . \qquad ( 1.12 )$$

In the course of the method, we will also be computing a series of trial solutions. We can compute the divergence of a sequence of trial solutions {\overline{x}¹,\overline{x}², . . . }

$$‖ {\overline{x}}^{2} - {\overline{x}}^{1} ‖ = {\sum }_{i} \vert {\overline{x}}_{i}^{2} - {\overline{x}}_{i}^{1} \vert . \qquad ( 1.13 )$$

The centered representation of a function relative to a given trial solution \overline{x} is

ƒ(x)=\overline{C}+\overline{A}(x−\overline{x})+B(x−\overline{x})(x−\overline{x}) (1.14)

where

$$\begin{matrix}\overline{A} = A + ( B + {B}^{*} ) \overline{x} ( = {A}_{ki} + {\sum }_{j} ( {B}_{kji} + {B}_{kij} ) {\overline{x}}_{j} ) \\ \overline{C} = C + A \overline{x} + B \overline{x} \overline{x} ( = {C}_{k} + {\sum }_{i} {A}_{ki} {\overline{x}}_{i} + {\sum }_{ij} {B}_{kji} {\overline{x}}_{j} {\overline{x}}_{i} )\end{matrix} . \qquad ( 1.15 )$$

By also defining

\overline{u}=u−\overline{x}

\overline{v}=v−\overline{x}

\overline{F}=F−B\overline{x}

\overline{G}=G−B\overline{x} (1.16)

the bounding inequalities are equivalent to the following centered inequalities

\overline{u}≦x−\overline{x}≦\overline{v}

\overline{F}≦B(x−\overline{x})≦\overline{G}. (1.17)

Also note that since \overline{u}≦0≦\overline{v}, we have

|xᵢ−\overline{x}ᵢ|≦max(|\overline{u}ᵢ|,|\overline{v}|ᵢ)≦vᵢ−uᵢ. (1.18)

In order to bound on both side, we will be decomposing x−\overline{x} into two nonnegative variables,

z−w=x−\overline{x}

z≧0

w≧0 (1.18)

to which we will apply the bounds

zᵢ+wᵢ≦max(|\overline{u}ᵢ|,|\overline{v}|ᵢ). (1.19)

The subsidiary problems are then

A) the basic quadratic feasibility problem

$$P0 = \{ x : \begin{matrix}{u}^{0} \leq x \leq {v}^{0} \\ lb \leq {f}^{1} ( x ) \leq ub\end{matrix} \} \qquad ( 1.20 )$$

and its optimization form

$$PO0 = \{ x : \begin{matrix}min {f}^{0} ( x ) \\ x ∈ P0\end{matrix} \} . \qquad ( 1.21 )$$

B) the basic quadratic problem with the bounding inequalities

$$Pbd ( u , v ) = \{ x : \begin{matrix}u \leq x \leq v \\ lb \leq {f}^{1} ( x ) \leq ub\end{matrix} \} \qquad ( \text{1.23} )$$

and its optimization form

$$PObd ( u , v ) = \{ x : \begin{matrix}min {f}^{0} ( x ) \\ x ∈ Pbd ( u , v )\end{matrix} \} . \qquad ( \text{1.24} )$$

C) the enveloping linear programming problem (using the formulas of (1.8), (1.15), and (1.16))

$$LP ( \overline{x} , u , v ) = \{ x , z , w : \begin{matrix}\overline{u} \leq x - \overline{x} \leq \overline{v} \\ l b \leq {\overline{C}}^{1} + {\overline{A}}^{1} ( x - \overline{x} ) + {\overline{G}}^{1} z - {\overline{F}}^{1} w \\ ub \geq {\overline{C}}^{1} + {\overline{A}}^{1} ( x - \overline{x} ) + {\overline{F}}^{1} z - {\overline{G}}^{1} w \\ x - \overline{x} = z - w \\ z + w \leq max ( \vert \overline{v} \vert , \vert \overline{u} \vert ) \\ z , w \geq 0\end{matrix} \} \qquad ( \text{1.25} )$$

its optimization form

$$LPO ( \overline{x} , u , v ) = \{ x : \begin{matrix}min {f}^{0} ( x ) = {A}^{0} x \\ x ∈ LP ( \overline{x} , u , v )\end{matrix} \} \qquad ( \text{1.26} )$$

and its minimal infeasibility form

$$LPMI ( \overline{x} , u , v ) = \{ x : \begin{matrix}min ⅇ ( G - F ) ( z + w ) \\ x ∈ LP ( \overline{x} , u , v )\end{matrix} \} . \qquad ( \text{1.27} )$$

E) and finally the linearization problem with the bounding inequalities included

$$LLP ( \overline{x} , u , v ) = \{ x : \begin{matrix}min {A}^{0} x \\ \overline{u} \leq x - \overline{x} \leq \overline{v} \\ l b \leq {\overline{C}}^{1} + {\overline{A}}^{1} ( x - \overline{x} ) \leq ub\end{matrix} \} . \qquad ( \text{1.28} )$$

### Method

The problems above have the following relationships.

Pbd(u,v)⊂LP(\overline{x},u,v)

If x′εLP(\overline{x},u,v)then

Pbd(u,v)∩LP(\overline{x},u,v)=Pbd(u,v)∩LP(x′,u,v)

If x′εLP(\overline{x},u,v)then

Δ(x′)≦e(G−F)(z′+w′)≦Δ(u,v)=e(G−F)(v−u)

(Note that it is also true that if Gₖᵢ−Fₖᵢ=0, then \overline{G}ₖᵢ=\overline{F}ₖᵢ=(B\overline{x})ₖᵢ=0, and that particular quadratic term will disappear from the constraint approximations in LP(\overline{x},u,v).)

As we search for a solution for a problem PO0, we split the region up into nodes, each of which is given by a set of bounds {u,v}.

For any problem, the theory of Newton's method tells us that there is a constant θ>0 such that for any Δ(u,v)<θ, if Pbd(u,v) is feasible then the sequence of trial solutions generated by the linearization, \overline{x}^{m+1}=LLP(\overline{x}^{m},u,v), will converge quadratically to the solution x*=Pbd(u,v), with

∥\overline{x}^{m+2}−\overline{x}^{m+1}∥≦a∥\overline{x}^{m+1}−\overline{x}^{m}∥².

On the other hand by the theorems proven here, there is a constant θ>0 such that for any Δ(u,v)<θ, if Pbd(u,v) is infeasible then LP(\overline{x},u,v) will be infeasible.

So a simplistic view of the method is to

1) Choose a node {u,v}, and find a trial solution u≦\overline{x}≦v,

2) Run \overline{x}^{m+1}=LLP(\overline{x}^{m},u,v) and see if it finds a feasible point,

3) Run xεLP(\overline{x},u,v) and see if it is infeasible,

4) If the node fails both (2) and (3), subdivide the node into smaller regions, and try again.

### Expanding a Node

An open node specifies a particular trial solution and bounds, {\overline{x},u,v}. It also specifies a particular distribution of the quadratic terms B+B* (see the Symmetry Breaking of the Gradient Terms section below).

To expand the node, apply the procedure below until the node is fully expanded, or has been closed. The procedure will update the problem, its trial solution and bounds, will establish the status of the node, and will update a rigorous lower bound \overline{φ} of the objective function on the node.

Note that in the course of searching for a suitable node to expand (see section below), it may be desirable to apply only steps (1), (2), (3), and (4) in order to see if there exists a linearization node which succeeds in step (2). This will be referred to as partial expansion.

There are two basic patterns of application of these steps

A) Run linearization alone as long as possible

Run steps (1), (2), (3), and (4) when partially expanding a node. Run steps (5) and (6) when fully expanding a node.

B) Always seed linearization with a minimal infeasibility trial solution

Run steps (1), (4), (5), (2) and (3) when partially expanding a node. Run steps (5) (rerun) and (6) when fully expanding a node. Step (2) should include multiple iterations of linearization, otherwise the quadratic convergence property will be lost.

Let ε>0 be the basic numerical tolerance desired.

1) Propagate the bounds through the problem (see the Convergence and Divergence of Trial Solutions section below). Update the node with the new bounds and/or problem terms

{u,v}={u′,v′}

{C,A,B}={C′,A′,B′}.

2) Try to solve the linearization problem LLP(\overline{x},u,v).

Optionally, one can solve a series of linearization problems, \overline{x}^{m+1}=LLP(\overline{x}^{m},u,v). The series should be ended when:

The problem becomes infeasible;

A fixed upper limit of iterations is reached;

The trial solutions converge; or

The trial solutions diverge.

At the end of this series, if there exists a solution x′εLLP(\overline{x},u,v), then use the solution as the new trial solution \overline{x}=x′, and declare the node linearized.

If there were a series of trial solutions found, then if the solutions converges or the upper limit reached, choose the final trial solution, but if the problem became infeasible or the trial solutions diverged, choose the trial solution with the minimum infeasibility, \overline{x}′=arg minₘΔ(\overline{x}^{m}).

If the series was ended because the solutions converged, declare the node convergent.

If the series was ended because the solutions diverged, declare the node divergent.

In any case, set the optimal lower bound to the worst bound on the node, \overline{φ}=(A⁰)₊u+(A⁰)₋v. (This will be reset in step 6, but is set here to support partial expansion.)

3) If step (2) succeeds in determining a trial solution, compute the infeasibility of the new trial solution, Δ(\overline{x}), and the maximum infeasibility of the bounds Δ(u,v).

If Δ(u,v)≦ε, all points satisfying x′εBd(\overline{x},u,v) are feasible within the desired tolerance. Declare the node completely feasible and point-optimal. If Δ(\overline{x})≦ε, then the trial solution is feasible within the desired tolerance. Declare the node point-feasible. (Note that completely feasible implies point-feasible.) (Note: if the node was convergent, it should be point-feasible.) If feasibility is all that is desired (as opposed to optimality), make the following substitution for steps (4)-(6)—If the node has been declared point-feasible, then close the node. If not, the node is completely expanded. Exit this procedure in either case.

If the node is linearized and point-feasible, then by the standard theory of Newton iteration, the trial solution is an approximate local solution to the nonlinear bounded problem Bd(u,v,F,G). Close the node and declare it point-optimal, and set the optimal lower bound for the node to the linearized optimum, \overline{φ}=A⁰\overline{x}.

Alternately, in the case where there are multiple local solutions within the same bounds, determine a local region within which the point is optimal, and close that newfound node, declaring it as point-optimal and point-feasible. Add a constraint to the original node such that the optimum must be strictly better than the found local optimum, A⁰x<\overline{φ}−ε and treat it as a new unopened node.

4) If step (2) fails, try to solve the enveloping minimal infeasibility problem LPMI(\overline{x},u,v).

If no such solution exists, close the node and declare it infeasible. Exit this procedure.

If there exists a solution x′εLPMI(\overline{x},u,v), then use the solution as the new trial solution \overline{x}=x′. (Also record the auxiliary variables {z′,w′}.)

5) Compute the infeasibility of the new trial solution, Δ(\overline{x}), and the maximum infeasibility of the bounds Δ(u,v).

If Δ(u,v)≦ε, all points satisfying x′εLPMI(\overline{x},u,v)are feasible within the desired tolerance. Declare the node completely feasible.

If Δ(\overline{x})≦ε, then the trial solution is feasible within the desired tolerance. Declare the node point-feasible. (Note that completely feasible implies point-feasible.)

6) If the node is not linearized, and is not infeasible, solve the enveloping optimal problem, x″εLPO(\overline{x},u,v). Set the optimal lower bound to the resulting minimum, \overline{φ}=A⁰x″.

If the node is completely feasible, then use the new solution as the new trial solution \overline{x}=x″, close the node, and declare it point-optimal. Exit this procedure.

If the node is point-feasible and the lower bound is close enough to the trial solution, |\overline{φ}−A⁰\overline{x}|≦ε, close the node, and declare it point-optimal. (Do NOT use the new solution as the trial solution.) Exit this procedure. Otherwise, the node is completely expanded. Exit this procedure.

Alternately, if feasibility is all that is desired (as opposed to optimality), make the following substitution for step (6)—If the node has been declared point-feasible, then close the node. If not, the node is completely expanded. Exit this procedure in either case.

### Choosing, Expanding, and Splitting a Node

Define φ* be the current best optimum found at a particular point in the search. That is

$${ϕ}^{*} = \{ \begin{matrix}min ( \overline{ϕ} ( N ) : N is a point \text{-} optimal node ) \\ ∞ if no point \text{-} optimal node exists\end{matrix} .$$

Let ε>0 be the basic numerical tolerance desired. Then we proceed as follows with the list of non-closed nodes.

1) For all non-closed nodes N, if \overline{φ}(N)≧φ*−ε, close the node and declare it sub-optimal. Also, we can close those with bounds equal within tolerance to the best as well as those with bounds strictly greater. Alternately, if feasibility is all that is desired (as opposed to optimality), this step can be skipped.

2) Choose a candidate set of nodes from the set of non-closed nodes according to the following.

If there are linearized nodes, select that set and proceed to step (3).

If there are nodes that have not yet been partially expanded, then partially expand nodes until either one is linearized, or all have been partially expanded, then go back to step (1).

At this point, one may optionally choose to fully expand all non-closed nodes, if there are any that need it, and go back to step (1).

If there are no fully expanded non-closed nodes and there are any non-closed nodes that have not been fully expanded, expand at least one of them and go back to step (1).

Select the set of expanded nodes and proceed to step (3).

Else all nodes have been closed, and you may terminate the procedure.

3) From the set of non-closed nodes, we wish to select one to split. From the set of chosen nodes, select an individual node according to one of the following possible measures.

The node with the smallest infeasibility of the trial solution, Δ(\overline{x}).

The node with the smallest \overline{φ}.

The node with the largest maximum infeasibility of the bounds, Δ(u,v).

These are suggested heuristics. Correctness only requires the expansion of an open node.

4) It is now time to subdivide the node.

We will subdivide the point range. Compute

$$w = \frac{( u + v )}{2} .$$

Optionally, one could also choose w=\overline{x} if one wants to subdivide at the points of linearization.

If the node is linearized, and divergent, we will compute the worst divergence

i*=arg max_{{i}}|\overline{x}ᵢ^{m+1}−\overline{x}ᵢ^{m}|.

If the node is not linearized, we will compute the dimension of the largest infeasibility according to the trial solution.

$${i}^{*} = arg {max}_{\{ i \}} {\sum }_{k} ( {G}_{ki} - {F}_{ki} ) ( {z}_{i} + {w}_{i} ) .$$

Otherwise, we can compute the dimension of the largest infeasibility according to the point bounds.

$${i}^{*} = arg {max}_{\{ i \}} {\sum }_{k} ( {G}_{ki} - {F}_{ki} ) ( {v}_{i} - {u}_{i} ) .$$

5) Close the node, and open two new nodes with the same problem, trial solution, and bounds are the newly closed node, except that for the first new open node,

uᵢ^{′}=uᵢ:∀i

vᵢ^{′}=vᵢ:∀i≠i*

v_{i*}^{′}=w_{i*}+ε/10

and for the second new open node,

uᵢ^{′}=uᵢ:∀i≠i*

u_{i*}^{′}=w_{i*}−ε/10.

vᵢ^{′}=vᵢ:∀i

### Initialization and Termination

To start the list of nodes, we require a problem {C,A,B}, a realistic set of finite bounds with a reasonable trial solution −∞<u≦\overline{x}≦v<∞ and a basic error tolerance ε.

To terminate the procedure, we continue to split, expand, and close nodes until all nodes have been closed. At that point we have either:

1) There exists a point-optimal node whose value is as minimal as any other node, and thus the trial solution of that node is the optimum solution of the original problem; or

2) All nodes are infeasible and so is the original problem. Alternately, if all we are interested in is feasibility, we only need look for any node that is point-feasible, in which case the trial solution is the feasible point.

### Convergence and Divergence of Trial Solutions

By the theory associated with Newton's method, if the bounded problem is feasible, and the initial trial solution is “sufficiently” close to the solution x*=Pbd(u,v), then the series of trial solutions will be quadratically convergent, with ∥\overline{x}^{m+2}−\overline{x}^{m+1}∥≦α∥\overline{x}^{m+1}−\overline{x}^{m}∥². If the problem is infeasible, or if the initial trial solution is not sufficiently close, then examples from chaos theory show that almost any behavior may occur.

So our criterion for convergence or divergence will be the following.

The trial solutions diverge if ∥\overline{x}^{m+2}−\overline{x}^{m+1}∥>∥\overline{x}^{m+1}−\overline{x}^{m}∥.

The trial solutions converge if ∥\overline{x}^{m+2}−\overline{x}m+1∥≦ε.

Otherwise, we pass no judgment.

The measures used for convergence/divergence are purely pragmatic, and the metric ∥.∥ can be chosen for convenience, so that for example either the sum of difference, or the maximum difference can be used.

### Simple Propagation of Bounds

Iterate the following propagations until no further improvement is seen. Alternately, include the square-free bound and the non-square-free bound propagations, until no improvement is found.

1) If there exists a {k′,i′}:(Gₖᵢ−Fₖᵢ)<ε, then to within the error tolerance, we can assume that

$${( Bx )}_{{k}^{′} {i}^{′}} = \frac{( {F}_{{k}^{′} {i}^{′}} + {G}_{{k}^{′} {i}^{′}} )}{2}$$

and we can then remove a quadratic term from the problem by adding the linear constraint

$$0 = - \frac{( {F}_{{k}^{′} {i}^{′}} + {G}_{{k}^{′} {i}^{′}} )}{2} + {\sum }_{j} {B}_{{k}^{′} {ji}^{′}} {x}_{j}$$

and modifying the original constraint

$${f}_{{k}^{′}} ( x ) = {C}_{{k}^{′}} + {\sum }_{i} {A}_{{k}^{′} i} {x}_{i} + {\sum }_{ij} {B}_{{k}^{′} ji} {x}_{j} {x}_{i}$$

$$to$$

$${f}_{{k}^{′}} ( x ) = {C}_{{k}^{′}} + {\sum }_{i} {A}_{{k}^{′} i} {x}_{i} + \frac{( {F}_{{k}^{′} {i}^{′}} + {G}_{{k}^{′} {i}^{′}} )}{2} {x}_{{i}^{′}} + {\sum }_{i \neq {i}^{′} j} {B}_{{k}^{′} ji} {x}_{j} {x}_{i} .$$

Let the new constraint have new index \hat{k}. Then

C′ₖ=Cₖ:∀k≠k′

$${C}_{{k}^{′}}^{′} = - \frac{( {F}_{{k}^{′} {i}^{′}} + {G}_{{k}^{′} {i}^{′}} )}{2}$$

A′ₖᵢ=Aₖᵢ:∀k≠k′∀i

A′_{k′i}=A_{k′i}:∀i≠i′

$${A}_{{k}^{′} {i}^{′}}^{′} = {A}_{{k}^{′} {i}^{′}} + \frac{( {F}_{{k}^{′} {i}^{′}} + {G}_{{k}^{′} {i}^{′}} )}{2}$$

A′_{\hat{k}i}=B_{k′ii′}:∀i

B′ₖⱼᵢ=Bₖⱼᵢ:∀k≠k′∀j∀i

B′_{k′ji}=B_{k′ji}:∀j∀i≠i′

B′_{k′ji′}=0:∀j

B′_{\hat{k}ji}=0:∀j∀i

2) For every linear constraint

$$k : {f}_{k} ( x ) = {C}_{k} + {\sum }_{i} {A}_{ki} {x}_{i}$$

we can determine new point bounds

$$∀ k ∈ {K}_{1} , {f}_{k} linear , ∀ i : \{ \begin{matrix}{A}_{ki} > 0 ⇒ {v}_{i}^{′} = min ( {v}_{i}^{′} , \frac{{ub}_{k} - {C}_{k}^{′} - {\sum }_{j \neq i} {( {A}_{kj} )}_{+} {u}_{j}^{′} - {\sum }_{j \neq i} {( {A}_{kj} )}_{-} {v}_{j}^{′}}{{A}_{ki}} ) \\ {A}_{ki} < 0 ⇒ {v}_{i}^{′} = min ( {v}_{i}^{′} , \frac{l {b}_{k} - {C}_{k}^{′} - {\sum }_{j \neq i} {( {A}_{kj} )}_{+} {v}_{j}^{′} - {\sum }_{j \neq i} {( {A}_{kj} )}_{-} {u}_{j}^{′}}{{A}_{ki}} )\end{matrix} \\ ∀ k ∈ {K}_{1} , {f}_{k} linear , ∀ i : \{ \begin{matrix}{A}_{ki} > 0 ⇒ {u}_{i}^{′} = max ( {u}_{i}^{′} , \frac{l {b}_{k} - {C}_{k}^{′} - {\sum }_{j \neq i} {( {A}_{kj} )}_{+} {v}_{j}^{′} - {\sum }_{j \neq i} {( {A}_{kj} )}_{-} {u}_{j}^{′}}{{A}_{ki}} ) \\ {A}_{ki} < 0 ⇒ {u}_{i}^{′} = max ( {u}_{i}^{′} , \frac{{ub}_{k} - {C}_{k}^{′} - {\sum }_{j \neq i} {( {A}_{kj} )}_{+} {u}_{j}^{′} - {\sum }_{j \neq i} {( {A}_{kj} )}_{-} {v}_{j}^{′}}{{A}_{ki}} )\end{matrix}$$

### Symmetry Breaking of the Gradient Terms

We can exploit the fact that the original quadratic functions only are affected by the value B+B* in order to attempt to reduce the degree of nonlinearity. This should be applied sparingly, as every time this rule is applied the gradient bounds deteriorate. It should definitely be applied at the initialization of the method.

Even if the heuristic below is not applied, the B used should be upper triangular under some permutation of the variables. That is, for any constraint k and variable pair {i, j}, either Bₖᵢⱼ=0 or Bₖⱼᵢ=0. This is to minimize the number of terms actually present in the quadratic expressions.

To apply the rule in the initial step, we redistribute the symmetric elements in B according to the heuristic rule of putting all the quadratic “weight” on the variable with the smallest range (break ties lexicographically)

(Initialization at iteration 0.)

$$∀ \{ k , i , j \} : if \vert {v}_{j} - {u}_{j} \vert < \vert {v}_{i} - {u}_{i} \vert , then \{ \begin{matrix}{B}_{kij}^{′} = {B}_{kij} + {B}_{kji} \\ {B}_{kji}^{′} = 0.\end{matrix}$$

To apply the rule in subsequent step, we redistribute the symmetric elements in B only if there is a significant difference between the variables' ranges

(At iteration m)

$$∀ \{ k , i , j \} : if \vert {v}_{j} - {u}_{j} \vert < {10}^{*} \vert {v}_{i} - {u}_{i} \vert and {B}_{kji} \neq 0 , \\ then \{ \begin{matrix}{B}_{kij}^{′} = {B}_{kij} + {B}_{kji} \\ {B}_{kji}^{′} = 0.\end{matrix}$$

### Square-Free Bound Propagation

Assume we have a quadratic function inequality

$$l {b}_{k} \leq {f}_{k} ( x ) = {C}_{k} + {\sum }_{i} {A}_{ki} {x}_{i} + {\sum }_{ij} {B}_{kji} {x}_{j} {x}_{i} \leq {ub}_{k}$$

a set of point bounds u≦x≦v, and wish to refine the bounds for a variable x_{J}. We will ignore any benefits of explicitly considering square terms x_{J}² in the function ƒₖ, (hence “square-free propagation”) although we will allow squared terms for variables other than x_{J} to appear. The Non-Square-Free Bound Propagation section explores the additional benefits of explicitly considering x_{J}².

In order to apply the Lemmas (see section below), we first rearrange the inequalities into the form

$$l {b}_{k} - {C}_{k} \leq {A}_{kJ} {x}_{J} + ( {\sum }_{i \neq J} ( {B}_{kJi} + {B}_{kiJ} ) {x}_{i} + {B}_{JJ} {x}_{J} ) {x}_{J} + {\sum }_{i \neq J} {A}_{ki} {x}_{i} + {\sum }_{i \neq J , j \neq J} {B}_{kji} {x}_{J} {x}_{i} \leq {ub}_{k} - {C}_{k}$$

and so if we define

$$β = ( {A}_{kJ} + {\sum }_{i \neq J} ( {B}_{kJi} + {B}_{kiJ} ) {x}_{i} + {B}_{JJ} {x}_{J} )$$

γ=βx_{J}

we also have

$$l {b}_{k} - {C}_{k} - {\sum }_{i \neq J} {A}_{ki} {x}_{i} - {\sum }_{i \neq J , j \neq J} {B}_{kji} {x}_{j} {x}_{i} \leq γ \leq {ub}_{k} - {C}_{k} - {\sum }_{i \neq J} {A}_{ki} {x}_{i} - {\sum }_{i \neq J , j \neq J} {B}_{kji} {x}_{j} {x}_{i}$$

From the Bounding Lemmas section, we define the bounding functions for multiply and square

μxy(x₀,x₁,y₀,y₁)=min(x₀y₀,x₁y₀,x₀y₁,x₁y₁)

vxy(x₀,x₁,y₀,y₁)=max(x₀y₀,x₁y₀,x₀y₁,x₁y₁)

μxx(x₀,x₁)=min(x₀²,(x₀x₁)₊,x₁²)

vxx(x₀,x₁)=max(x₀²,(x₀x₁)₊,x₁²).

We then define bounds β₀≦β≦β₁ and γ₀≦γ≦γ₁ for {β,γ}

$$\begin{matrix}{β}_{0} = {A}_{kJ} + {\sum }_{i \neq J} {( {B}_{kJi} + {B}_{kiJ} )}_{+} {u}_{i} + {\sum }_{i \neq J} {( {B}_{kJi} + {B}_{kiJ} )}_{-} {v}_{i} + {( {B}_{JJ} )}_{+} {u}_{j} + \\ {( {B}_{JJ} )}_{-} {v}_{J} \\ {β}_{1} = {A}_{kJ} + {\sum }_{i \neq J} {( {B}_{kJi} + {B}_{kiJ} )}_{+} {v}_{i} + {\sum }_{i \neq J} {( {B}_{kJi} + {B}_{kiJ} )}_{-} {u}_{i} + {( {B}_{JJ} )}_{+} {v}_{j} + \\ {( {B}_{JJ} )}_{-} {u}_{J} \\ {γ}_{0} = l {b}_{k} - {C}_{k} - {\sum }_{i \neq J} {( {A}_{ki} )}_{+} {v}_{i} - {\sum }_{i \neq J} {( {A}_{ki} )}_{-} {u}_{i} - \\ {\sum }_{i \neq J , j \neq J , i \neq j} {( {B}_{kji} )}_{+} vxy ( {u}_{j} , {v}_{j} , {u}_{i} , {v}_{i} ) - \\ {\sum }_{i \neq J , j \neq J , i \neq j} {( {B}_{kji} )}_{-} μ xy ( {u}_{j} , {v}_{j} , {u}_{i} , {v}_{i} ) - \\ {\sum }_{i \neq J} {( {B}_{kii} )}_{+} vxx ( {u}_{i} , {v}_{i} ) - {\sum }_{i \neq J} {( {B}_{kii} )}_{-} μ xx ( {u}_{i} , {v}_{i} ) \\ {γ}_{1} = u {b}_{k} - {C}_{k} - {\sum }_{i \neq J} {( {A}_{ki} )}_{+} {u}_{i} - {\sum }_{i \neq J} {( {A}_{ki} )}_{-} {v}_{i} - \\ {\sum }_{i \neq J , j \neq J , i \neq j} {( {B}_{kji} )}_{+} μ xy ( {u}_{j} , {v}_{j} , {u}_{i} , {v}_{i} ) - \\ {\sum }_{i \neq J , j \neq J , i \neq j} {( {B}_{kji} )}_{-} vxy ( {u}_{j} , {v}_{j} , {u}_{i} , {v}_{i} ) - \\ {\sum }_{i \neq J} {( {B}_{kii} )}_{+} μ xx ( {u}_{i} , {v}_{i} ) - {\sum }_{i \neq J} {( {B}_{kii} )}_{-} v xx ( {u}_{i} , {v}_{i} )\end{matrix}$$

Form the set {β₀,β₁,γ₀γ₁}. We now need to split up the set into the cases considered in Lemma B.4.

For each set {β₀,β₁,γ₀,γ₁}, if it is the case that β₀≦0≦β₁, then split the set into two sets, {β₀,0,γ₀,γ₁} and {0,β₁,γ₀,γ₁}.

For each set {β₀,β₁,γ₀,γ₁}, if it is the case that γ₀≦0≦γ₁, then split the set into two sets, {β₀,β₁,γ₀,0} and {β₀,β₁,0γ₁}.

Up to four separate sets may result from this procedure.

For each set B^{m}={β₀,β₁,γ₀,γ₁}, use Lemma B.4 to compute a range u′ₘ≦x_{J}≦v′ₘ for each set. Restrict each range by the original bounds (allowing for the possibility that the range will be empty).

u′ₘ=max(u_{J},u′ₘ)

v′ₘ=min(v_{J},v′ₘ)

Given the resulting sets of ranges {{u′ₘ, v′ₘ}:m=1 . . . M}, the variable will be in their union,

$${x}_{J} ∈ {⋃}_{m} \{ {u}_{m}^{′} , {v}_{m}^{′} \} .$$

One can simplify them by sorting first by u′ₘ then by v′ₘ and then iteratively applying the following rule until no further simplifications are possible

1) If u′ₘ≦u′ₘ₊₁ and u′ₘ₊₁≦v′ₘ then {min(u′ₘ, u′ₘ₊₁), max(v′ₘ,v′ₘ₊₁)}={u′ₘ,v′ₘ}∪{u′ₘ₊₁,v′ₘ₊₁} can replace both ranges.

2) If v′ₘ<u′ₘ, then delete the interval as being infeasible.

Given a set of multiple simplified ranges, there are two possible ways to apply them to the original node

A) By conservatively bounding the multiple ranges, the node with bounds N={{u_{J}, v_{J}},{uᵢ,vᵢ}:i≠J} can be refined to N={{minₘ(u′ₘ), maxₘ(v′ₘ)};{uᵢ,vᵢ}:i≠J}.

B) The node with bounds N={{u_{J},v_{J}},{uᵢ,vᵢ}:i≠i J} can be split into multiple refined nodes N_{m={{u′}ₘ,v′ₘ},{uᵢ,vᵢ}:i≠J}.

C) A third option would be to look at the benefit of splitting according to (B) over using the simple bounds of (A) by computing the ratio of the ranges

$$ρ = \frac{\sum ( {v}_{m}^{′} - {u}_{m}^{′} )}{{max}_{m} ( {v}_{m}^{′} ) - {min}_{m} ( {u}_{m}^{′} )} .$$

and only splitting the node if the benefit is sufficient, say ρ≦.5 (the equivalent of one subdivision).

### Non-Square-Free Bound Propagation

The procedure here is similar to that in the Square-Free Bound Propagation section, except that the squared term x_{J}² does appear in the function ƒₖ, so the defined bounds β₀≦β≦β₁ and γ₀≦γ≦γ₁ will differ by a factor of the reciprocal of the coefficient of x_{J}², and Lemma B.5 will be invoked instead of Lemma B.4.

In order to apply the Lemmas, we first rearrange the inequalities into the form

$$l {b}_{k} - {C}_{k} \leq {A}_{kJ} {x}_{J} + ( {\sum }_{i \neq J} ( {B}_{kJi} + {B}_{kiJ} ) {x}_{i} ) {x}_{J} + {B}_{kJJ} {x}_{J}^{2} + {\sum }_{i \neq J} {A}_{ki} {x}_{i} + {\sum }_{i \neq J , j \neq J} {B}_{kji} {x}_{j} {x}_{i} \leq {ub}_{k} - {C}_{k}$$

and so if we define

$$β = \frac{( {A}_{kJ} + {\sum }_{i \neq J} ( {B}_{kJi} + {B}_{kiJ} ) {x}_{i} )}{{B}_{kJJ}}$$

γ=βx_{J}+x_{J}²

we also have

$$l {b}_{k} - {C}_{k} - {\sum }_{i \neq J} {A}_{ki} {x}_{i} - {\sum }_{i \neq J , j \neq J} {B}_{kji} {x}_{j} {x}_{i} \leq {B}_{kJJ} γ \leq {ub}_{k} - {C}_{k} - {\sum }_{i \neq J} {A}_{ki} {x}_{i} - {\sum }_{i \neq J , j \neq J} {B}_{kji} {x}_{j} {x}_{i}$$

We use the same bounding functions from the Square-Free Bound Propagation section.

We then define bounds β₀≦β≦β₁ and γ₀≦γ≦γ₁ for {β,γ} based on the sign of B_{kJJ}

$${\hat{β}}_{0} = {A}_{kJ} + {\sum }_{i \neq J} {( {B}_{kJi} + {B}_{kiJ} )}_{+} {u}_{i} + {\sum }_{i \neq J} {( {B}_{kJi} + {B}_{kiJ} )}_{-} {v}_{i}$$

$${\hat{β}}_{1} = {A}_{kJ} + {\sum }_{i \neq J} {( {B}_{kJi} + {B}_{kiJ} )}_{+} {v}_{i} + {\sum }_{i \neq J} {( {B}_{kJi} + {B}_{kiJ} )}_{-} {u}_{i}$$

If B_{kJJ}>0

$${β}_{0} = \frac{{\hat{β}}_{0}}{{B}_{kJJ}}$$

$${β}_{1} = \frac{{\hat{β}}_{1}}{{B}_{kJJ}}$$

$${γ}_{0} = \frac{{\hat{γ}}_{0}}{{B}_{kJJ}}$$

$${γ}_{1} = \frac{{\hat{γ}}_{1}}{{B}_{kJJ}}$$

If B_{kJJ}<0

$${β}_{0} = \frac{{\hat{β}}_{1}}{{B}_{kJJ}}$$

$${β}_{1} = \frac{{\hat{β}}_{0}}{{B}_{kJJ}}$$

$${γ}_{0} = \frac{{\hat{γ}}_{1}}{{B}_{kJJ}}$$

$${γ}_{1} = \frac{{\hat{γ}}_{0}}{{B}_{kJJ}}$$

We now follow the same procedure as in the Square-Free Bound Propagation section, except that we apply Lemma B.5 to the generation of the ranges

$${x}_{J} ∈ {⋃}_{m} \{ {u}_{m}^{′} , {v}_{m}^{′} \} .$$

Note that unlike Lemma B.4, each case in Lemma B.5 may themselves generate multiple or empty ranges.

### Proofs for Nonlinear Function Problems

For the time being, let us consider only feasibility, although the same approach applies to optimization as well.

Let ƒ(x): [symbol] ⁿ→ [symbol] ^{m} be a function with Lipschitz-continuous derivatives.

Assume we have a trial solution \overline{x}. By the mean value theorem, for every point x there exists a point \tilde{x} (on the segment between \overline{x} and x) such that

ƒₖ(x)=ƒₖ(\overline{x})+∇ƒₖ(\tilde{x})(x−\overline{x}) (A.1)

Within a set of point bounds,

u≦x≦v (A.2)

there exist gradient bounds

Fₖ(u,v)=inf{∇ƒₖ(x):u≦x≦v}

Gₖ(u,v)=sup{∇ƒₖ(x):u≦x≦v} (A.3)

so that

u≦x≦v [symbol] F≦∇ƒ(x)≦G (A.4)

(For notational convenience, we will suppress the functional dependence of F and G on u and v.)

We will assume that the trial solution satisfies the bounds

u≦\overline{x}≦v (A.5)

If we define

\overline{u}=u−\overline{x}

\overline{v}=v−\overline{x}

\overline{F}=F−∇ƒ(\overline{x})

\overline{G}=G−∇ƒ(\overline{x}) (A.6)

we will get the enveloping inequalities

$$\overline{u} \leq x - \overline{x} \leq \overline{v} ⇒ f ( \overline{x} ) + ∇ f ( \overline{x} ) ( x - \overline{x} ) + {F ( x - \overline{x} )}_{+} + {G ( x - \overline{x} )}_{-} \leq f ( x ) \leq f ( \overline{x} ) + ∇ f ( \overline{x} ) ( x - \overline{x} ) + {G ( x - \overline{x} )}_{+} + {F ( x - \overline{x} )}_{-} . \qquad \text{(A.7)}$$

Now consider the following series of problems

$$\begin{matrix}P0 = \{ x : \begin{matrix}{u}^{0} \leq x \leq {v}^{0} \\ l b \leq f ( x ) \leq ub\end{matrix} \} & \text{(A.8)} \\ Pbd ( u , v ) = \{ x : \begin{matrix}u \leq x \leq v \\ l b \leq f ( x ) \leq ub\end{matrix} \} & \text{(A.9)} \\ LP ( \overline{x} , u , v ) = \{ x , z , w : \begin{matrix}\overline{u} \leq x - \overline{x} \leq \overline{v} \\ l b \leq f ( \overline{x} ) + ∇ f ( \overline{x} ) ( x - \overline{x} ) + \overline{G} z - \overline{F} w \\ ub \geq f ( \overline{x} ) + ∇ f ( \overline{x} ) ( x - \overline{x} ) + \overline{F} z - \overline{G} w \\ x - \overline{x} = z - w \\ z + w \leq max ( \vert \overline{v} \vert , \vert \overline{u} \vert ) \\ z , w \geq 0\end{matrix} \} & \text{(A.10)}\end{matrix}$$

Define the infeasibility of a particular point to be

Δₖ(x)=max((ƒₖ(x)−ubₖ)₊,(lbₖ−ƒₖ(x))₊) (A.11)

(As a result Δ(x)≧0, and Δ(x)=0 only if the point x is feasible.)

Theorem 1

T1-1) For every xεP0, there exist bounds {u,v) such that xεPbd(u,v).

T1-2) Pbd(u,v)⊂LP(\overline{x},u,v).

T1-3) For every {x,u,v}εLP(\overline{x},u,v),

Δ(x)≦(G−F)(z+w)≦(G−F)max(|\overline{u}|,|\overline{v}|)≦(G−F)(v−u).

Corollary 1

Pbd(u,v)∩LP(\overline{x},u,v)=Pbd(u,v)∩LP(x′,u,v),

For the quadratic problem,

ƒ(x)=C+Ax+Bxx (A.12)

and we can find

$$\tilde{x} = \frac{1}{2} ( x + \overline{x} )$$

∇ƒ(\overline{x})=\overline{A}=A+(B+B*)\overline{x}

∇ƒ(\tilde{x})−Δƒ(\overline{x})=B(x−\overline{x}) (A.13)

so we can compute a set of gradient bounds

F=(B)₊u+(B)₋v

G=(B)₊v+(B)₋u (A.14)

so that

u≦x≦v [symbol] F≦Bx≦G

[symbol]

\overline{F}=F−B\overline{x}≦B(x−\overline{x}l )=∇ƒ(\tilde{x})−∇ƒ(\overline{x})≦G−B\overline{x}=\overline{G}. (A.15)

### Bounding Lemmas

Lemma B.1

Let z=xy. If x₀≦x≦x₁ and y₀≦y≦y₁, then

min(x₀y₀,x₁y₀,x₀y₁,x₁y₁)≦z≦max(x₀y₀,x₁y₀,x₀y₁,x₁y₁)

Lemma B.2

Let z=x². If x₀≦x≦x₁, then

min(x₀²,(x₀x₁)₊,x₁²)≦z≦max(x₀²,(x₀x₁)₊,x₁²)

Or equivalently, Lemma B.3

Let z=x². If x₀≦x≦x₁, then

a) If x₀≦x₁≦0 or 0≦x₀≦x₁ then

min(x₀²,x₁²)≦z≦max(x₀²,x₁²)

b) If x₀≦0≦x₁ then

0≦z≦max(x₀²,x₁²)

Lemma B.4

Let γ=βx. If β₀≦β≦β₁ and γ₀≦γ≦γ₁, then

I) If 0≦β₀≦β₁ and 0≦γ₀≦γ₁ then

$$\frac{{γ}_{0}}{{β}_{1}} \leq x \leq \frac{{γ}_{1}}{{β}_{0}} ( \frac{{γ}_{0}}{{β}_{1}} \leq x \leq ∞ if {β}_{0} = 0 )$$

II) If β₀≦β₁≦0 and 0≦γ₀≦γ₁, then

$$\frac{{γ}_{1}}{{β}_{1}} \leq x \leq \frac{{γ}_{0}}{{β}_{0}} ( - ∞ \leq x \leq \frac{{γ}_{0}}{{β}_{0}} if {β}_{1} = 0 )$$

III) If 0≦β₀≦β₁ and γ₀≦γ₁≦0 then

$$\frac{{γ}_{0}}{{β}_{0}} \leq x \leq \frac{{γ}_{1}}{{β}_{1}} ( - ∞ \leq x \leq \frac{{γ}_{1}}{{β}_{1}} if {β}_{0} = 0 )$$

IV) If β₀≦β₁≦0 and γ₀≦γ₁≦0, then

$$\frac{{γ}_{1}}{{β}_{0}} \leq x \leq \frac{{γ}_{0}}{{β}_{1}} ( \frac{{γ}_{1}}{{β}_{0}} \leq x \leq ∞ if {β}_{1} = 0 )$$

The following is an equivalent form, more convenient in some cases Lemma B.4′

Let γ=βx. If β₀≦β≦β₂ and γ₀≦γ≦γ₁, then

I,III) If 0≦β₀≦β₁ then

$$min ( \frac{{γ}_{0}}{{β}_{0}} , \frac{{γ}_{0}}{β1} ) \leq x \leq max ( \frac{{γ}_{1}}{{β}_{0}} , \frac{{γ}_{1}}{{β}_{1}} ) ( \frac{1}{{β}_{0}} \approx ∞ if {β}_{0} = 0 )$$

II,IV) If β₀≦β₁≦0, then

$$min ( \frac{{γ}_{1}}{{β}_{0}} , \frac{{γ}_{1}}{{β}_{1}} ) \leq x \leq max ( \frac{{γ}_{0}}{{β}_{0}} , \frac{{γ}_{0}}{{β}_{1}} ) ( \frac{1}{{β}_{1}} \approx - ∞ if {β}_{1} = 0 )$$

Lemma B.5—(Note that Cases I and II result in identical results.)

Let γ=βx+x². If β₀≦β≦β₁ and γ₀≦γ≦γ₁, then

I) If 0≦β₀≦β₁ and 0≦γ₀≦γ₁ then

$$- \frac{{β}_{1}}{2} - \sqrt{\frac{{β}_{1}^{2}}{4} + {γ}_{1}} \leq x \leq - \frac{{β}_{0}}{2} + \sqrt{\frac{{β}_{0}^{2}}{4} + {γ}_{1}}$$

or more accurately,

$$either - \frac{{β}_{1}}{2} - \sqrt{\frac{{β}_{1}^{2}}{4} + {γ}_{1}} \leq x \leq - \frac{{β}_{0}}{2} - \sqrt{\frac{{β}_{0}^{2}}{4} + {γ}_{0}}$$

$$or - \frac{{β}_{1}}{2} + \sqrt{\frac{{β}_{1}^{2}}{4} + {γ}_{0}} \leq x \leq - \frac{{β}_{0}}{2} + \sqrt{\frac{{β}_{0}^{2}}{4} + {γ}_{1}}$$

II) If β₀≦β₁≦0 and 0≦γ₀≦γ₁, then

$$- \frac{{β}_{1}}{2} - \sqrt{\frac{{β}_{1}^{2}}{4} + {γ}_{1}} \leq x \leq - \frac{{β}_{0}}{2} + \sqrt{\frac{{β}_{0}^{2}}{4} + {γ}_{1}}$$

or more accurately,

$$either - \frac{{β}_{1}}{2} - \sqrt{\frac{{β}_{1}^{2}}{4} + {γ}_{1}} \leq x \leq - \frac{{β}_{0}}{2} - \sqrt{\frac{{β}_{0}^{2}}{4} + {γ}_{0}}$$

$$or - \frac{{β}_{1}}{2} + \sqrt{\frac{{β}_{1}^{2}}{4} + {γ}_{0}} \leq x \leq - \frac{{β}_{0}}{2} + \sqrt{\frac{{β}_{0}^{2}}{4} + {γ}_{1}}$$

III) If 0≦β₀≦β₁ and γ₀≦γ₁≦0 then

III.a) If

$$\frac{{β}_{1}^{2}}{4} + {γ}_{1} < 0 ,$$

then there are no possible solutions for x.

III.b) If

$$\frac{{β}_{1}^{2}}{4} + {γ}_{1} \geq 0 ,$$

then

$$- \frac{{β}_{1}}{2} - \sqrt{\frac{{β}_{1}^{2}}{4} + {γ}_{1}} \leq γ \leq - \frac{{β}_{1}}{2} + \sqrt{\frac{{β}_{1}^{2}}{4} + {γ}_{1}}$$

or more accurately,

either

$$- \frac{{β}_{1}}{2} - \sqrt{\frac{{β}_{1}^{2}}{4} + {γ}_{1}} \leq x \leq - \frac{{β}_{0}}{2} - \sqrt{{( \frac{{β}_{0}^{2}}{4} + {γ}_{0} )}_{+}}$$

or

$$- \frac{{β}_{0}}{2} + \sqrt{{( \frac{{β}_{0}^{2}}{4} + {γ}_{0} )}_{+}} \leq x \leq - \frac{{β}_{1}}{2} + \sqrt{\frac{{β}_{1}^{2}}{4} + {γ}_{1}}$$

IV) If β₀≦β₁≦0 and γ₀≦γ₁≦0, then

III.a) If

$$\frac{{β}_{0}^{2}}{4} + {γ}_{1} < 0 ,$$

then there are no possible solutions for x.

III.b) If

$$\frac{{β}_{0}^{2}}{4} + {γ}_{1} \geq 0 ,$$

then

$$- \frac{{β}_{0}}{2} - \sqrt{\frac{{β}_{0}^{2}}{4} + {γ}_{1}} \leq x \leq - \frac{{β}_{0}}{2} + \sqrt{\frac{{β}_{0}^{2}}{4} + {γ}_{1}}$$

or more accurately,

either

$$- \frac{{β}_{0}}{2} - \sqrt{\frac{{β}_{0}^{2}}{4} + {γ}_{1}} \leq x \leq - \frac{{β}_{1}}{2} - \sqrt{{( \frac{{β}_{1}^{2}}{4} + {γ}_{0} )}_{+}}$$

or

$$- \frac{{β}_{1}}{2} + \sqrt{{( \frac{{β}_{1}^{2}}{4} + {γ}_{0} )}_{+}} \leq x \leq - \frac{{β}_{0}}{2} + \sqrt{\frac{{β}_{0}^{2}}{4} + {γ}_{1}}$$

### Gradient Bound Subdivision

It is also viable for the quadratic-only problem to subdivide the gradient bounds directly, e.g. by choosing a dimension {k′,i′} and subdividing that gradient bound, e.g. at

$${H}_{ki} = \frac{{F}_{ki} + {G}_{ki}}{2} ,$$

or Hₖᵢ=(B\overline{x})ₖᵢ if subdivision at the linearization points is desired. In that case, (1.9) no longer applies, so it is necessary to include the gradient inequalities F≦Bx≦G directly in the problems (1.23)-(1.28) as explicit inequalities. Theorem 1 and Corollary 1 will still apply.

If one is subdividing the gradients, then there is additional bound propagation between the point bounds and the gradient bounds that can be defined

1) To refine the gradient bounds

F′=max(F, (B)₊u+(B)₋v)

G′=min(G, (B)₊v+(B)₋u)

2) To refine the point upper bounds

∀j:v′ⱼ=vⱼ

$$∀ k , i , j : \{ \begin{matrix}{B}_{kji} > 0 ⇒ {v}_{j}^{′} = min ( {v}_{j}^{′} , \frac{{G}_{ki}^{′} - {\sum }_{\hat{j} \neq j} {( {B}_{k \hat{j} i} )}_{+} {u}_{\hat{j}}^{′} - {\sum }_{\hat{j} \neq j} {( {B}_{k \hat{j} i} )}_{-} {v}_{\hat{j}}^{′}}{{B}_{kji}} ) \\ {B}_{kji} < 0 ⇒ {v}_{j}^{′} = min ( {v}_{j}^{′} , \frac{{F}_{ki}^{′} - {\sum }_{\hat{j} \neq j} {( {B}_{k \hat{j} i} )}_{+} {v}_{\hat{j}}^{′} - {\sum }_{\hat{j} \neq j} {( {B}_{k \hat{j} i} )}_{-} {u}_{\hat{j}}^{′}}{{B}_{kji}} )\end{matrix}$$

To refine the point lower bounds

∀j:u′ⱼ=uⱼ

$$∀ k , i , j : \{ \begin{matrix}{B}_{kji} > 0 ⇒ {u}_{j}^{′} = max ( {u}_{j}^{′} , \frac{{F}_{ki}^{′} - {\sum }_{\hat{j} \neq j} {( {B}_{k \hat{j} i} )}_{+} {v}_{\hat{j}}^{′} - {\sum }_{\hat{j} \neq j} {( {B}_{k \hat{j} i} )}_{-} {u}_{\hat{j}}^{′}}{{B}_{kji}} ) \\ {B}_{kji} < 0 ⇒ {u}_{j}^{′} = max ( {u}_{j}^{′} , \frac{{G}_{ki}^{′} - {\sum }_{\hat{j} \neq j} {( {B}_{k \hat{j} i} )}_{+} {u}_{\hat{j}}^{′} - {\sum }_{\hat{j} \neq j} {( {B}_{k \hat{j} i} )}_{-} {v}_{\hat{j}}^{′}}{{B}_{kji}} )\end{matrix}$$

Robust Linear Propagation

The following modifies (2) in the Simple Propagation of Bounds to account for possible numerical problems. Let ε>0 be our numerical tolerance. For every linear constraint

$$k : {f}_{k} ( x ) = {C}_{k} + {\sum }_{i} {A}_{ki} {x}_{i}$$

and for every variable xᵢ which appears in ƒₖ and such that |Aₖᵢ|>ε, we define the following at each stage of the iteration where the bounds at that iteration are {u, v}.

$$\begin{matrix}{p}_{ki} = {lb}_{k} - {C}_{k} - {\sum }_{j \neq i} {( {A}_{kj} )}_{+} {v}_{j} - {\sum }_{j \neq i} {( {A}_{kj} )}_{-} {u}_{j} \\ {q}_{ki} = {ub}_{k} - {C}_{k} - {\sum }_{j \neq i} {( {A}_{kj} )}_{+} {u}_{j} - {\sum }_{j \neq i} {( {A}_{kj} )}_{-} {v}_{j} \\ {Δ}_{ki} = ϵ ( 1 + {\sum }_{j \neq i} ( \vert {A}_{kj} \vert + max ( \vert {u}_{j} \vert , \vert {v}_{j} \vert ) ) )\end{matrix}$$

We can determine then determine new point bounds

$$\begin{matrix}∀ k ∈ {K}_{1} , {f}_{k} linear , ∀ i : \{ \begin{matrix}{A}_{ki} > ϵ ⇒ {v}_{i}^{′} = max ( {u}_{j} - \vert 1 + {u}_{j} \vert , min ( {v}_{i} , max ( \frac{{q}_{ki} + {Δ}_{ki}}{{A}_{ki} - ϵ} , \frac{{q}_{ki} + {Δ}_{ki}}{{A}_{ki} + ϵ} ) ) ) \\ {A}_{ki} < - ϵ ⇒ {v}_{i}^{′} = max ( {u}_{j} - \vert 1 + {u}_{j} \vert , min ( {v}_{i} , max ( \frac{{p}_{ki} + {Δ}_{ki}}{{A}_{ki} - ϵ} , \frac{{p}_{ki} + {Δ}_{ki}}{{A}_{ki} + ϵ} ) )\end{matrix} \\ ∀ k ∈ {K}_{1} , {f}_{k} linear , ∀ i : \{ \begin{matrix}{A}_{ki} > ϵ ⇒ {u}_{i}^{′} = min ( {v}_{j} + \vert 1 + {v}_{j} \vert , max ( {u}_{i} , min ( \frac{{p}_{ki} + {Δ}_{ki}}{{A}_{ki} - ϵ} , \frac{{p}_{ki} + {Δ}_{ki}}{{A}_{ki} + ϵ} ) ) ) \\ {A}_{ki} < - ϵ ⇒ {u}_{i}^{′} = min ( {v}_{j} + \vert 1 + {v}_{j} \vert , max ( {u}_{i} , min ( \frac{{q}_{ki} + {Δ}_{ki}}{{A}_{ki} - ϵ} , \frac{{q}_{ki} + {Δ}_{ki}}{{A}_{ki} + ϵ} ) ) )\end{matrix}\end{matrix}$$

### Numerically Robust Square-Free Bound Propagation

The following modifies the Square-Free Bound Propagation to account for possible numerical problems. Let ε>0 be our numerical tolerance.

For convenience, define the following error bound on the product xy

Δxy(x₀,x₁,y₀,y₁)=εmax(|x₀|,|y₀|,|x₁|,|y₁|)

From the Bounding Lemmas, we define the robust bounding functions for multiply and square

μ^{ε}xy(x₀,x₁,y₀,y₁)=min(x₀y₀,x₁y₀,x₀y₁,x₁y₁)−Δxy(x₀,x₁,y₀,y₁)

v^{ε}xy(x₀,x₁,y₀,y₁)=max(x₀y₀,x₁y₀,x₀y₁,x₁y₁)+Δxy(x₀,x₁,y₀,y₁)

μ^{ε}xx(x₀,x₁)=min(x₀²,(x₀x₁)₊,x₁²)−Δxy(x₀,x₁,x₀,x₁)

v^{ε}xx(x₀,x₁)=max(x₀²,(x₀x₁)₊,x₁²)+Δxy(x₀,x₁,x₀,x₁)

We then define rigorous bounds β₀^{ε}≦β≦β₁^{ε} and γ₀^{ε}≦γ≦γ₁^{ε} for {β,γ}

$$\begin{matrix}\begin{matrix}\begin{matrix}{β}_{0}^{ϵ} = {A}_{kJ} - ϵ + {\sum }_{i \neq J} {( {B}_{kJi} + {B}_{kiJ} - ϵ )}_{+} ( {u}_{i} - ϵ ) + \\ {\sum }_{i \neq J} {( {B}_{kJi} + {B}_{kiJ} - ϵ )}_{-} ( {v}_{i} + ϵ ) + {( {B}_{JJ} - ϵ )}_{+} ( {u}_{J} - ϵ ) -\end{matrix} \\ \begin{matrix}{β}_{1}^{ϵ} = {A}_{kJ} + ϵ + {\sum }_{i \neq J} {( {B}_{kJi} + {B}_{kiJ} + ϵ )}_{+} ( {v}_{i} + ϵ ) + \\ {\sum }_{i \neq J} {( {B}_{kJi} + {B}_{kiJ} + ϵ )}_{-} ( {u}_{i} - ϵ ) + {( {B}_{JJ} + ϵ )}_{+} ( {v}_{J} + ϵ ) -\end{matrix}\end{matrix} \\ \begin{matrix}{γ}_{0}^{ϵ} = {lb}_{k} - {C}_{k} - ϵ - {\sum }_{i \neq J} {( {A}_{ki} + ϵ )}_{+} ( {v}_{i} + ϵ ) - {\sum }_{i \neq J} {( {A}_{ki} + ϵ )}_{-} ( {u}_{i} - ϵ ) - \\ {\sum }_{i \neq J , j \neq J , i \neq j} {( {B}_{kji} + ϵ )}_{+} {ν}^{ϵ} xy ( {u}_{j} , {v}_{j} , {u}_{i} , {v}_{i} ) - \\ {\sum }_{i \neq J , j \neq J , i \neq j} {( {B}_{kji} + ϵ )}_{-} {μ}^{ϵ} xy ( {u}_{j} , {v}_{j} , {u}_{i} , {v}_{i} ) - \\ {\sum }_{i \neq J} {( {B}_{kii} + ϵ )}_{+} {ν}^{ϵ} xx ( {u}_{i} , {v}_{i} ) - {\sum }_{i \neq J} {( {B}_{kii} + ϵ )}_{-} {μ}^{ϵ} xx ( {u}_{i} , {v}_{i} )\end{matrix} \\ \begin{matrix}{γ}_{1}^{ϵ} = {ub}_{k} - {C}_{k} + ϵ - {\sum }_{i \neq J} {( {A}_{ki} - ϵ )}_{+} ( {u}_{i} - ϵ ) - {\sum }_{i \neq J} {( {A}_{ki} - ϵ )}_{-} ( {v}_{i} + ϵ ) - \\ {\sum }_{i \neq J , j \neq J , i \neq j} {( {B}_{kji} - ϵ )}_{+} {μ}^{ϵ} xy ( {u}_{j} , {v}_{j} , {u}_{i} , {v}_{i} ) - \\ {\sum }_{i \neq J , j \neq J , i \neq j} {( {B}_{kji} - ϵ )}_{-} {ν}^{ϵ} xy ( {u}_{j} , {v}_{j} , {u}_{i} , {v}_{i} ) - \\ {\sum }_{i \neq J} {( {B}_{kii} - ϵ )}_{+} {μ}^{ϵ} xx ( {u}_{i} , {v}_{i} ) - {\sum }_{i \neq J} {( {B}_{kii} - ϵ )}_{-} {ν}^{ϵ} xx ( {u}_{i} , {v}_{i} )\end{matrix} \\ \end{matrix}$$

We now follow the identical process as in (2.8) replacing the original set {β₀,β₁,γ₀,γ₁} by the set {β₀^{ε},β₁^{ε,γ}₀^{ε},γ₁^{ε}}.

### Numerically Robust Non-Square-Free Bound Propagation

The following modifies the Non-Square-Free Bound Propagation to account for possible numerical problems. Let ε>0 be our numerical tolerance. Define the robust bounding functions for multiply and square as in the Numerically Robust Square-Free Bound Propagation section.

We define rigorous bounds β₀^{ε}≦β≦β₁^{ε} and γ₀^{ε}≦γ≦γ₁^{ε} for {β,γ} based on the sign of B_{kJJ}

$$\begin{matrix}\begin{matrix}\begin{matrix}{\hat{β}}_{0}^{ϵ} = {A}_{kJ} - ϵ + {\sum }_{i \neq J} {( {B}_{kJi} + {B}_{kiJ} - ϵ )}_{+} ( {u}_{i} - ϵ ) + \\ {\sum }_{i \neq J} {( {B}_{kJi} + {B}_{kiJ} - ϵ )}_{-} ( {v}_{i} + ϵ )\end{matrix} \\ \begin{matrix}{\hat{β}}_{1}^{ϵ} = {A}_{kJ} + ϵ + {\sum }_{i \neq J} {( {B}_{kJi} + {B}_{kiJ} + ϵ )}_{+} ( {v}_{i} + ϵ ) + \\ {\sum }_{i \neq J} {( {B}_{kJi} + {B}_{kiJ} + ϵ )}_{-} ( {u}_{i} - ϵ )\end{matrix}\end{matrix} \\ \begin{matrix}{\hat{γ}}_{0}^{ϵ} = {lb}_{k} - {C}_{k} - ϵ - {\sum }_{i \neq J} {( {A}_{ki} + ϵ )}_{+} ( {v}_{i} + ϵ ) - {\sum }_{i \neq J} {( {A}_{ki} + ϵ )}_{-} ( {u}_{i} - ϵ ) - \\ {\sum }_{i \neq J , j \neq J , i \neq j} {( {B}_{kji} + ϵ )}_{+} {ν}^{ϵ} xy ( {u}_{j} , {v}_{j} , {u}_{i} , {v}_{i} ) - \\ {\sum }_{i \neq J , j \neq J , i \neq j} {( {B}_{kji} + ϵ )}_{-} {μ}^{ϵ} xy ( {u}_{j} , {v}_{j} , {u}_{i} , {v}_{i} ) - \\ {\sum }_{i \neq J} {( {B}_{kii} + ϵ )}_{+} {ν}^{ϵ} xx ( {u}_{i} , {v}_{i} ) - {\sum }_{i \neq J} {( {B}_{kii} + ϵ )}_{-} {μ}^{ϵ} xx ( {u}_{i} , {v}_{i} )\end{matrix} \\ \begin{matrix}{\hat{γ}}_{1}^{ϵ} = {ub}_{k} - {C}_{k} + ϵ - {\sum }_{i \neq J} {( {A}_{ki} - ϵ )}_{+} ( {u}_{i} - ϵ ) - {\sum }_{i \neq J} {( {A}_{ki} - ϵ )}_{-} ( {v}_{i} + ϵ ) - \\ {\sum }_{i \neq J , j \neq J , i \neq j} {( {B}_{kji} - ϵ )}_{+} {μ}^{ϵ} xy ( {u}_{j} , {v}_{j} , {u}_{i} , {v}_{i} ) - \\ {\sum }_{i \neq J , j \neq J , i \neq j} {( {B}_{kji} - ϵ )}_{-} {ν}^{ϵ} xy ( {u}_{j} , {v}_{j} , {u}_{i} , {v}_{i} ) - \\ {\sum }_{i \neq J} {( {B}_{kii} - ϵ )}_{+} {μ}^{ϵ} xx ( {u}_{i} , {v}_{i} ) - {\sum }_{i \neq J} {( {B}_{kii} - ϵ )}_{-} {ν}^{ϵ} xx ( {u}_{i} , {v}_{i} )\end{matrix} \\ \end{matrix}$$

We now follow the same process as in the Non-Square-Free Bound Propagation section replacing the original set {\hat{β}₀,\hat{β}₁,\hat{γ}₀,\hat{γ}₁} by the set {\hat{β}₀^{ε},\hat{β}₁^{ε},\hat{γ}₀^{ε},\hat{γ}₁^{ε}}.

### Bound Propagation for Mixing Functions

A common equation for refinery and chemical processes is a mixing equation of the form

x₀(y₁+y₂+ . . . +yₙ)=x₁y₁+x₂y₂+ . . . +xₙyₙ (G.1)

where

y₁≧0, y₂≧0, . . . , yₙ≧0.

Here we are given materials indexed by {1,2, . . . ,n), and recipe sizes (or rates, or masses, or ratios, whatever mixing unit of interest) {y₁, y₂, . . , yₙ) for a mix of the materials. Then (G.1) represents a simple mixing model for a property x₀ of the resulting mix given values {x₁,x₂, . . . ,xₙ) for the property of each of the materials.

In this case, the resulting property will be a convex linear combination of the individual properties. Hence if we are given bounds

a₁≦x₁≦b₁, a₂≦x₂≦b₂, . . . ,a_{n≦}xₙ≦bₙ (G.2)

we can derive the bounds

x₀≧min(a₁,a₂, . . . ,aₙ)

x₀≦max(b₁,b₂, . . . ,bₙ) (G.3)

It is to be understood that the above description it is intended to be illustrative, and not restrictive. Many other embodiments are possible and some will be apparent to those skilled in the art, upon reviewing the above description. For example the local linear bounding and the local linearization can be performed in the opposite order, and more. Therefore, the spirit and scope of the appended claims should not be limited to the above description. The scope of the invention should be determined with reference to the appended claims, along with the full scope of equivalents to which such claims are entitled.

What is claimed is:

1. A method of solving an operations problem, comprising:
receiving variables, relationships, and constraints;
forming a set of non-convex quadratic equations based on the variables, relationships, and constraints;
solving the set of non-convex quadratic equations by applying a bound propagation process, a local linear bounding process, a local linearization process, and a global subdivision search; and
determining whether a solution is optimal, feasible, or infeasible.

2. The method of claim 1, wherein the solution is a schedule for a manufacturing process.

3. The method of claim 2, wherein the solution is a schedule for operating an oil refinery.

4. The method of claim 1, wherein the solution is a plan for a manufacturing process.

5. The method of claim 4, wherein the solution is a plan for operating an oil refinery.

6. A machine-accessible medium having associated content capable of directing the machine to perform a method of solving a set of non-convex quadratic equations, the method comprising:
selecting a region bounding all variables;
applying a bound propagation process to the region to refine the bounds and improve linearization;
applying a local linear bounding process to the region to determine feasibility and to find approximately feasible solutions;
applying a local linearization process to the region to determine feasibility and local optimality;
upon finding an optimal global solution, providing the optimal global solution and information indicating optimality;
upon finding a feasible global solution, providing the feasible global solution and information indicating feasibility;
upon determining local infeasibility, eliminating the region from consideration;
upon determining global infeasibility, providing information indicating infeasibility; and
upon not finding a solution, applying a global subdivision search to the region to produce two or more regions and iteratively applying the bound propagation, local linear bounding, and local linearization processes to each of the two or more regions, until determining the solution is optimal, feasible, or infeasible.

7. The machine-accessible medium as recited in claim 6, further comprising:
receiving input variables, constraints, and equations.

8. The machine-accessible medium as recited in claim 6, further comprising:
receiving a measure of optimality used to determine the global optimal solution.

9. The machine-accessible medium as recited in claim 6, further comprising:
receiving a measure of feasibility used to determine the global feasible solution.

10. The machine-accessible medium as recited in claim 6, further comprising:
providing a schedule for operating a plant.

11. The machine-accessible medium as recited in claim 6, further comprising:
providing a plan for operating a plant.

12. A process of solving a set of non-convex quadratic equations, comprising:
selecting a region bounding all variables;
applying a bound propagation process to the region to refine the bounds and improve linearization;
applying a local linear bounding process to the region to determine feasibility and to find approximately feasible solutions;
applying a local linearization process to the region to determine feasibility and local optimality;
upon finding a solution after the local linearization process, providing the solution;
upon determining infeasibility, eliminating the region from consideration; and
upon not finding the solution after the local linearization process, applying a global subdivision search to the region to produce two or more regions and iteratively applying the bound propagation, local linear bounding, and local linearization processes to each of the two or more regions, until determining the solution is optimal, feasible, or infeasible.

13. The process as recited in claim 12, wherein the local linearization process is the local linear bounding process.

14. The process as recited in claim 12, wherein the local linear bounding process comprises:
performing differentiation on equations in the region;
determining lower and upper bounds on the variables in the region;
applying a linear programming process to the linear equations in the region;
determining whether a solution exists in the region;
upon finding a solution exists, determining local feasibility; and
upon finding local infeasibility, determining global infeasibility.

15. The process as recited in claim 12, wherein the local linearization process comprises:
performing differentiation at a point in the bounded region;
forming a set of linear equations;
applying a linear programming process to the linear equations in the bounded region; and
generating a new point in the bounded region and repeating the local linearization process with the new point.

16. The process as recited in claim 12, wherein applying a global subdivision search to the region to produce two or more regions comprises:
maintaining a list of non-closed nodes;
selecting a candidate set of nodes from the list;
selecting a chosen node from the candidate set;
subdividing a point range of the chosen node;
closing the chosen node; and
opening two new nodes that subdivide the chosen node.

17. The process as recited in claim 16, wherein selecting the candidate set of nodes is done by selecting linearized nodes.

18. The process as recited in claim 16, wherein selecting the candidate set of nodes is done by expanding nodes that have not yet been partially expanded.

19. The process as recited in claim 16, wherein selecting the candidate set of nodes is done by selecting expanded nodes.

20. The process as recited in claim 16, wherein subdividing the two new nodes that subdivide the chosen node comprises:
subdividing a point range;
upon determining the chosen node is linearized and divergent, computing a worst divergence; and
upon determining the chosen node is not linearized, computing a dimension of largest infeasibility.
